(19) United States
(12) Patent Application Publication
(10) Pub. No.: US 2025/0267037 A1
(43) Pub. Date: Aug. 21, 2025

(54) METHOD FOR GENERATING A NON-JITTERING TRIGGER SIGNAL IN A NODE OF A SERIAL DATA RING-BUS

(71) Applicant: SAAB AB, Linköping (SE)

(72) Inventor: Gilbert BENGTSSON, Ytterby (SE)

(21) Appl. No.: 18/857,045

(22) PCT Filed: Apr. 25, 2022
(86) PCT No.: PCT/SE2022/050397

§ 371 Date: Oct. 15, 2024

(51) Int. Cl. H04L 12/423

(52) U.S. Cl. CPC H04L 12/423

(57) ABSTRACT

A method for providing a trigger signal in a slave node (S1-SN) in a data ring-bus (1) is described. the method comprising the steps of receiving a master clock signal on the clock input (5), updating a slot counter value C with 1 for each clock cycle of the master clock signal received. and resetting the slot counter value C to 1 after the slot counter value C has reached a maximum value. Max, receiving a first data message on the data input (6), adjusting the slot counter value C to S, for the clock cycle in which the end of the first data message was received, wherein S is in the interval 2 to Max−1, receiving a subsequent data message after the first data message, and providing a trigger signal when the slot counter value C equals T, if the end of the subsequent data message is received when the slot counter value C is valid.

### TECHNICAL FIELD

The present invention relates to a method for generating a non-jittering trigger signal in a node of a serial data ring-bus and to a node of a serial data ring-bus configured to generate a non-jittering trigger signal.

### BACKGROUND ART

Data ring-buses are common in a variety of technical applications. A serial data ring-bus comprises a master node and a plurality of slave nodes. The master node is connected with the slave nodes by means of a databus which connects all the slave nodes in series. The master node and the slave nodes can transmit and receive messages on the data bus. In addition to the databus the master node is also connected to the slave nodes by means of one or more clockbuses. The slave nodes may be connected in series in a ring also by the clock bus. Alternatively, each one of the slave nodes may be connected directly to the master node with a separate clock bus in a so called starcoupling. The data on the ring-bus may be serial data or parallel data. It is more common to send the data on the ring-bus as serial data.

A message sent from the master node on the databus may be a message with a question to one or more of the slave nodes to provide information, such as, e.g., status of the slaves, to the master node. Alternatively, the message sent from the master node on the databus may be a trigger message triggering an event in one or more of the slave nodes. As the messages in the ring-bus are transmitted from slave node to slave node there is a delay from reception of a message at a slave node to the transmission of the message from the slave node. The delay is predictable but may vary due to, e.g., jittering of the trigger signal.

### SUMMARY OF THE INVENTION

An object of the present invention is to provide a method for generating a non-jittering trigger signal in a slave node of a data ring-bus.

Another object of the present is to provide a device configured to be arranged as a slave node in a data ring-bus.

One of these objects is fulfilled with a method according to the independent method claim.

Another of these objects is fulfilled with a device according to the independent device claim.

According to a first aspect a method is provided for providing a trigger signal in a slave node in a data ring-bus, which slave node comprises a clock input and a data input. The method comprises the steps of receiving a master clock signal on the clock input, updating a slot counter value C with 1 for each clock cycle of the master clock signal received on the clock input, and resetting the slot counter value C to 1 after the slot counter value C has reached a maximum value, Max, wherein Max is an integer >2. The method also comprises the steps of receiving a first data message on the data input, adjusting the slot counter value C to S, for the clock cycle in which the end of the first data message was received, wherein S is in the interval 2 to Max−1, receiving a subsequent data message after the first data message, and providing a trigger signal when the slot counter value C equals T, if the end of the subsequent data message is received when the slot counter value C is valid, wherein a valid slot counter value C is S, and at least one of S−1 and S+1, wherein T≥S+1, and wherein T≤Max.

The data signal is such that a data message is sent with an interval being X⋅Max, wherein X is an integer. By having the slot counter set in the interval 2 to Max−1 it is possible for the data signal to jitter one slot forward or backwards while still receiving the data message in the same interval of the slot counter, i.e., in the same interval 1−Max of the slot counter. By having T≥S+1 and T≤Max it is assured that the trigger signal is provided no earlier than at the end of reception of a message and no later than before reset of the slot counter. The method is preferably controlled by clocked logic in the slave node.

The method according to the first aspect provides a trigger signal which is jitter free.

S−1 may be considered to be a valid slot counter value C if the end of a subsequent data message is received when the slot counter value C is S−1 before the reception of the end of a subsequent data message when the slot counter value C is S+1, and S+1 may be considered to be a valid slot counter value C if the end of a subsequent data message is received when the slot counter value C is S+1 before the reception of the end of a subsequent data message when the slot counter value C is S−1. The jitter may only occur between two adjacent slots. As long as the end of the data messages are received in the same slot as for the first message it is not possible to know between which two slots the end of the data message could jitter. When the first data message which has jittered is received it is possible to determine between which two slots the end of the data message can jitter. The determined two slots are set to be considered as valid while all other slots are set as invalid.

An error message may be generated if the end of a subsequent data message is received when the slot counter value C is not valid. If the end of a data message is received when the slot counter value is not valid it is due to another reason than jitter. No trigger signal is provided if an error message is generated.

The slot counter value C may be reset if an error message has been generated for a predetermined number of times and/or with a predetermined frequency. By resetting the slot counter value is meant that the slot counter value C is set to S for the clock cycle in which the end of the next data message is received.

Max may be equal to 5. This leaves space for valid slots to be 2-4 and for the trigger to be provided in a slot after reception of the end of a data message.

S may be equal to 3 when Max is equal to 5. Thus, valid counter values may be 2, 3 or 4.

T may be equal to 5 when Max is equal to 5. This assures that the trigger signal is provided at least one clock cycle after the reception of the end of the data message.

According to a second aspect a device if provided which is configured to be arranged as a slave node in a data ring-bus. The device comprises a clock input and a data input, wherein the device is configured to update a slot counter value C with 1 for each clock cycle of a master clock signal received on the clock input, and resetting the slot counter value C to 1 after the slot counter value C has reached a maximum value, Max, wherein Max is an integer >2. The device is also configured to adjust, when a first data message is received on the data input, the slot counter value C for the clock cycle in which the end of the first data message was received to a value S, wherein S is in the interval 2 to Max−1, and to provide a trigger signal when the slot counter value C equals T, if the end of a subsequent data message, received after the first data message, is received when the slot counter value C is valid, wherein the device is configured to treat S as a valid slot counter value C, wherein T>S+1, and wherein T≤Max.

The data signal is such that a data message is sent with an interval being X⋅Max, wherein X is an integer. By having the slot counter set in the interval 2 to Max−1 it is possible for the data signal to jitter one slot forward or backwards while still receiving the data message in the same interval of the slot counter, i.e., in the same interval 1−Max of the slot counter. By having T≥S+1 and T≤Max it is assured that the trigger signal is provided no earlier than at the end of reception of a message and no later than before reset of the slot counter.

The device is preferably controlled by a processor in the slave node. The processor may in turn be controlled by a computer program.

The device according to the second aspect provides a trigger signal which is jitter free.

The device may be configured to treat N−1 as a valid slot counter value C if the end of a subsequent data message is received when the slot counter value C is N−1 before the reception of the end of a subsequent data message when the slot counter value C is N+1, and wherein the device is configured to treat N+1 as a valid slot counter value C if the end of a subsequent data message is received when the slot counter value C is N+1 before the reception of the end of a subsequent data message when the slot counter value C is N−1. The jitter may only occur between two adjacent. As long as the end of the data messages are received in the same slot as for the first message it is not possible to know between which two slots the end of the data message could jitter. When the first data message which has jittered is received it is possible to determine between which two slots the end of the data message can jitter. All slots that are not considered valid are considered to be invalid.

The device may be configured to generate an error message if the end of a subsequent data message is received when the slot counter value C is not valid. If the end of a data message is received when the slot counter value is not valid it is due to another reason than jitter. No trigger signal is provided if an error message is generated.

The features described for the method may be combined also with the device according to the second aspect. Thus, the slot counter value C may be reset if an error message has been generated for a predetermined number of times and/or with a predetermined frequency. By resetting the slot counter value is meant that the slot counter value C is set to S for the clock cycle in which the end of the next data message is received.

Max may be equal to 5. This leaves space for valid slots to be 2-4 and for the trigger to be provided in a slot after reception of the end of a data message.

S may be equal to 3 when Max is equal to 5. Thus, valid counter values may be 2, 3 or 4.

T may be equal to 5 when Max is equal to 5. This assures that the trigger signal is provided at least one clock cycle after the reception of the end of the data message.

The method may comprise the step of issuing an event in the slave node in response to the trigger signal.

After detection of the trigger message a delay may be added before the event is issued to compensate for the serial bus delay so that the event occurs at the nearly the same time in all slaves. It will be nearly the same time as it is not possible to predict the actual delay due to the jitter aspect, but the method according to the invention resolves the problem with trigger to trigger jitter. The delay should be different for different slave nodes to compensate for the position of the slave node in the ring bus.

According to a third aspect a data ring-bus is provided comprising a master node and a plurality of devices, according to the above description, as slave nodes in the data ring-bus. The master node is configured to send messages with an interval of X⋅Max, wherein X is an integer which has a fixed value. There might be periods where no trigger message is sent and X may change value after a number messages have been sent. As an example Max might be 5 and 27 messages could be sent with a period of 1000 (5*200). Then there might be a pause of 800 (5*160) followed by 40 new trigger messages with a period of 900 (5*180)

According to a fourth aspect a computer program is provided for providing a trigger signal in a device, comprising a clock input and a data input, comprising instructions which, when executed by a processor in the device cause the processor to control the device to carry out the method according to the first aspect. In the following detailed description embodiments of the invention will be described with reference to the appended drawings.

### BRIEF DESCRIPTION OF THE DRAWINGS

FIG. 1 shows a data ring-bus with a master node and slave nodes.

FIG. 2 shows a number of slots/clock cycles in which a message may be received and where a trigger signal is provided.

### DETAILED DESCRIPTION

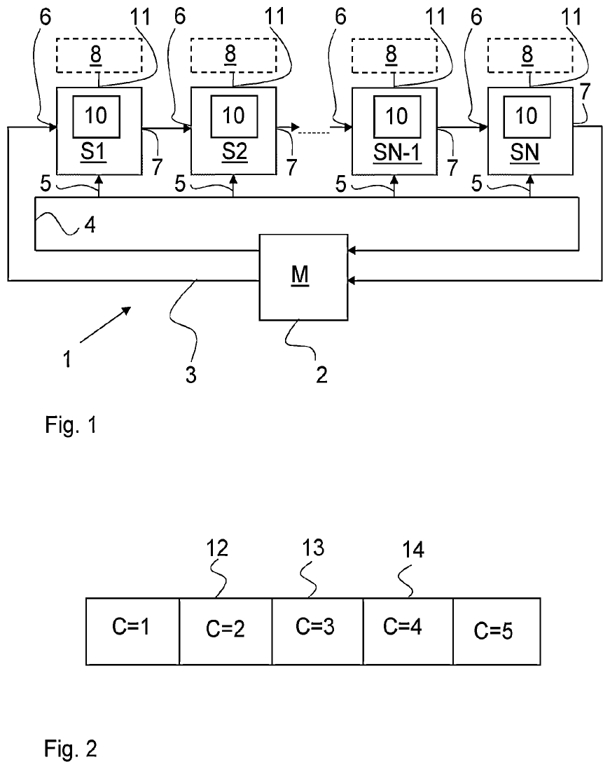

FIG. 1 shows a data ring-bus 1 with a master node 2 and slave nodes S1-SN. The slave nodes S1-SN are connected to each other by means of a data ring-bus 3. Each slave node has a data input 6 and a data output 7. The data bus 4 is connected to the input 6 of each slave node S1-SN. Each slave node read the data signal on the data bus 4 in order to check whether the data signal contains any message to that slave node S1-SN. In case the message is not intended for that slave node or only contains information for the slave node to take some action, the slave node may output the data signal on the data output 7 as soon as possible with as little delay as possible. If, however, the data signal contains a message requesting information from that slave node, S1-SN, the slave node, S1-SN, must use the data bus 4 to send a response. This implies that the master node have to schedule the request messages so that the slave node has enough time to answer without interrupting the trigger messages.

The data signal may comprise a trigger signal for triggering an event in the slave node. The trigger signal may come at periodic intervals in order to trigger events with predetermined intervals. For some applications it is important that the trigger signal in each slave node occurs with a interval which is a multiple of a predetermined time period. An example of an application in which it is important to have the trigger signal at intervals which are multiples of such a predetermined time period is a radar of the type active electronically scanned array (AESA). Each element of the AESA is a slave node in the data ring-bus, i.e., each slave node is thus equipped with a radar emitter 8 as is shown with dashed lines in FIG. 1. The radar emitter 8 is connected to the trigger output 11

The slave nodes S1-SN are also connected to each other by means of a clock bus 4. The master node 2 sends a clock signal on the clock bus 4. Each slave node S1-SN receives the clock signal and transmits it to the next slave node S1-SN. The clock bus continues through each one of the slave nodes S1-SN. Each slave node S1-SN has a clock input 5 on which the slave node S1-SN detects the clock signal on the bus as is indicated in FIG. 1. In a data ring bus as shown in FIG. 1 the data message will have to be retrieved using data recovery. Data recovery from a data signal is a technique that is well known to a person skilled in the art and will not be explained in more detail here. Each slave node comprises a processor 10 which is configured to control the slave node S1-SN. A computer program controls the operation of the processor 10. The processor 10 comprises a trigger output 11 for a trigger signal.

The method for providing a trigger signal in a slave node S1-SN in the data ring-bus 1 will now be described. The slave node S1-SN receives a master clock signal on the clock input. The slave node S1-SN updates a slot counter value C with 1 for each clock cycle of the master clock signal received on the clock input, and resets the slot counter value C to 1 after the slot counter value C has reached Max, wherein Max is an integer >2. When the slave node receives a first data message on the data input, the slave node adjusting the slot counter value C to S, for the clock cycle in which the end of the first data message was received, wherein S is in the interval 2 to Max−1. FIG. 2 illustrates the slot counter C. In the embodiment shown in FIG. 2 Max is 5, i.e., the slot counter will count from 1 to 5 and then return to 1. The slot counter C is set to 3 for the clock cycle in which the end of the first data message was received, i.e., it is defined that the end of the first data message is received in the third slot 13 as is illustrated in FIG. 2. Due to jittering a subsequent data message, received after the first data message, may be received in the second slot 12 or the fourth slot 14. The second slot 12, the third slot 13 and the fourth slot 14 are defined as valid slots. It the end of a subsequent data message is received in the second slot 12 it is determined that it is in a valid slot and a trigger signal is provided when the slot counter value C equals 5, i.e., in the last slot before reset of the slot counter value. It would be possible to provide the trigger signal when the counter value equals 4 but in case the end of a subsequent data message was received in the fourth slot there would be very little time to provide the trigger signal. By providing the trigger signal when the counter value C equals 5 the trigger signal will not jitter. It should be understood that a end of a data message is not received every time the slot counter is equal to three. An end of a data message is received with an interval being interval being equal to 5X, wherein X is an integer. The method is not dependent on the frequency of the data signal which, typically, has a frequency of 1-100 MHz.

When the end of a subsequent message is received in the second slot the fourth slot is set as invalid. The fourth slot is set as invalid as jittering can only result in the end of the data message jumping between two adjacent slots or clock cycles. Any larger jump is not due to jitter but may be due to, e.g., that the master node has restarted. Thus, after jittering of the data signal has occurred

If the end of the subsequent data message is received when the slot counter value C is invalid no trigger signal is provided. Instead, an error message may be issued. In case of a predetermined number of trigger messages in a row that are detected in an invalid slot, the slave node may reset the slot counter and set the slot counter for the end of the next data message to 3. Alternatively or additionally, the slave node may send a message to the master node requesting the master node to initiate an action such as, e.g., restarting.

The device may be configured to treat N−1 as a valid slot counter value C if the end of a subsequent data message is received when the slot counter value C is N−1 before the reception of the end of a subsequent data message when the slot counter value C is N+1, and wherein the device is configured to treat N+1 as a valid slot counter value C if the end of a subsequent data message is received when the slot counter value C is N+1 before the reception of the end of a subsequent data message when the slot counter value C is N−1.

The computer program mentioned above comprises instructions which, when executed by a processor in a device comprising a clock input and a data input cause the processor to control the device to carry out the method as described above.

The above described embodiments may be amended in many ways without departing from the scope of the present invention, which is limited only by the appended claims.

1. Method for providing a trigger signal in a slave node (S1-SN) in a data ring-bus (1), which slave node (S1-SN) comprises a clock input (5) and a data input (6), the method comprising the steps of:
receiving a master clock signal on the clock input (5),
updating a slot counter value C with 1 for each clock cycle of the master clock signal received on the clock input (5), and resetting the slot counter value C to 1 after the slot counter value C has reached a maximum value, Max, wherein Max is an integer >2,
receiving a first data message on the data input (6),
adjusting the slot counter value C to S, for the clock cycle in which the end of the first data message was received, wherein S is in the interval 2 to Max−1,
receiving a subsequent data message after the first data message, and
providing a trigger signal when the slot counter value C equals T, if the end of the subsequent data message is received when the slot counter value C is valid, wherein a valid slot counter value C is S and at least one of S−1 and S+1, wherein T≥S+1 and wherein T≤Max.

2. The method according to claim 1, wherein S−1 is a valid slot counter value C if the end of a subsequent data message is received when the slot counter value C is S−1 before the reception of the end of a subsequent data message when the slot counter value C is S+1, and wherein S+1 is a valid slot counter value C if the start of a subsequent data message is received when the slot counter value C is S+1 before the reception of the start of a subsequent data message when the slot counter value C is S−1.

3. The method according to claim 1, wherein an error message is generated if the end of a subsequent data message is received when the slot counter value C is not valid.

4. The method according to claim 3, wherein the slot counter value C is reset if an error message has been generated for a predetermined number of times and/or with a predetermined frequency.

5. The method according to claim 1, wherein Max is equal to 5.

6. The method according to claim 5, wherein S is equal to 3.

7. The method according to claim 5, wherein T is equal to 5.

8. The method according to claim 1, comprising the step of issuing an event in the slave node in response to the trigger signal.

9. The method according to claim 8, wherein after detection of the trigger message, a delay is added before the event is issued.

10. A device (S1-SN) configured to be arranged as a slave node (S1-SN) in a data ring-bus (1), comprising a clock input (5) and a data input (6), wherein the device is configured
to update a slot counter value C with 1 for each clock cycle of a master clock signal received on the clock input (5), and resetting the slot counter value C to 1 after the slot counter value C has reached a maximum value, Max, wherein Max is an integer >2,
to adjust, when a first data message is received on the data input (6), the slot counter value C for the clock cycle in which the end of the first data message was received to a value S, wherein S is in the interval 2 to Max−1, and
to provide a trigger signal when the slot counter value C equals T, if the end of a subsequent data message, received after the first data message, is received when the slot counter value C is valid, wherein the device is configured to treat S, and at least one of S−1 and S+1, as a valid slot counter value C, wherein T≥S+1, and wherein T≤Max.

11. The device according to claim 10, configured to treat N−1 as a valid slot counter value C if the end of a subsequent data message is received when the slot counter value C is N−1 before the reception of the end of a subsequent data message when the slot counter value C is N+1, and wherein the device is configured to treat N+1 as a valid slot counter value C if the end of a subsequent data message is received when the slot counter value C is N+1 before the reception of the end of a subsequent data message when the slot counter value C is N−1.

12. The device according to claim 10 or 11, configured to generate an error message if the end of a subsequent data message is received when the slot counter value C is not valid.

13. The device according to claim 12, configured to reset the slot counter value C if an error message has been generated for a predetermined number of times and/or with a predetermined frequency.

14. The device according to claim 10, wherein Max is equal to 5.

15. The device according to claim 14, wherein S is equal to 3.

16. The device according to claim 14, wherein T is equal to 5.

17. A data ring-bus (1) comprising a master node (M) and a plurality of devices (S1-SN) according to claim 8 as slave nodes (S1-SN) in the data ring-bus (1).

18. Computer program for providing a trigger signal in a device (S1-SN), comprising a clock input (5) and a data input (6), comprising instructions which, when executed by a processor (10) in the device (S1-SN) causes the processor (10) to control the device (S1-SN) to carry out the method according to claim 1.
